(19) United States
(12) Patent Application Publication
(10) Pub. No.: US 2014/0224555 A1
(43) Pub. Date: Aug. 14, 2014

(54) Telescopic Crawler Chassis and Engineering Machinery Having the Same

(71) Applicants: Huanyun Qian, Changsha (CN); Qinghua He, Changsha (CN); Jianxin Zhu, Changsha (CN)

(72) Inventors: Huanyun Qian, Changsha (CN); Qinghua He, Changsha (CN); Jianxin Zhu, Changsha (CN)

(73) Assignee: SUNWARD INTELLIGENT EQUIPMENT CO., LTD., Changsha (CN)

(21) Appl. No.: 13/824,546

(22) PCT Filed: Nov. 30, 2011
(86) PCT No.: PCT/CN11/83264

§ 371 Date: Mar. 18, 2013

(30) Foreign Application Priority Data
Oct. 11, 2011 (CN) 201110305831.6

(51) Int. Cl. B62D 55/084

(52) U.S. Cl. CPC B62D 55/084
USPC 180/9.48

(57) ABSTRACT

The present invention relates to a telescopic crawler chassis and engineering machinery having the telescopic crawler chassis, comprising a left crawler frame, a right crawler frame and a base, further comprising at least one hollow left sliding beam and at least one right sliding beam. One end of the hollow left sliding beam is fixedly connected with the left crawler frame, and one end of the right sliding beam is fixedly connected with the right crawler frame. At least one hollow sliding seat is arranged on the base, one end of the hollow left sliding beam is movably inserted into an hollow sliding seat from the left end of the hollow sliding seat, and one end of the right sliding beam is movably inserted into an hollow sliding seat and also into the hollow part of the hollow left sliding beam from the right end of the hollow sliding seat. The change or conversion of the state of the engineering machinery can be more convenient, and the whole machine walks and operates more stably, safely and reliably.

### CROSS REFERENCE TO RELATED APPLICATION

This application claims the priority of Chinese patent application with application No. 201110305831.6, and filed on Oct. 11, 2011, and all disclosed contents thereof should be incorporated herein by reference.

### TECHNICAL FIELD OF THE INVENTION

The present invention relates to a crawler chassis technique for engineering machinery, in particular, to a telescopic crawler chassis and engineering machinery having the same.

### BACKGROUND OF THE INVENTION

In the field of chassis of engineering machinery, owing to the adaptability and flexibility of the crawler-type walking mode, a crawler chassis is widely applied in the engineering machinery, such as pile drivers, drilling machines and cranes.

With the development of the engineering technology, engineering operation raises higher requirements to the crawler-type engineering machinery. For example, in recent years, pile foundation engineering in the constructional engineering develops swiftly, Skyscrapers are built increasingly, and the diameter and depth of the pile foundation also increase increasingly. The increase of the diameter and depth of the pile foundation raises higher requirements for the stability of the piling machinery, which requires that the width of the crawler chassis can be extended in the construction operation. Likewise, other engineering operations also raise the same requirements to the corresponding crawler-type engineering machinery, which requires that the crawler chassis can have a larger width to ensure the stability of the engineering machinery in the construction operation.

Although increase of the width of the crawler chassis can solve the stability problem during the construction operation, mere increase of the width of the crawler chassis means enlargement of the width of the chassis and increase of the weight thereof. Thus problems are caused such as increase of manufacturing cost, increase of energy consumption in operation, inconvenient transition transportation. In order to coordinate the stability of the construction operation and the flexibility of the transition transportation, the present crawler-type construction machinery has already had a telescopic structure, that is, a telescopic crawler chassis has been already proposed. The crawler chassis has two states: an operating state and a field transition state. In the process of the construction operation, the crawler chassis is in the operation state, crawler frames on the two sides extend toward the two sides respectively, and thus the width of the crawler chassis is extended to improve the stability of the construction machinery. In the process of field transition state, the chassis is in the state of transition, crawler frames on the two sides shrink, thus the width of the crawler chassis is decreased, so the transition transportation is more convenient.

The well-known crawler chassis, such as that issued on page 79 to page 92 of Chapter five of Piling Machinery published by Mechanic Industry Press, is generally a crawler chassis borrowings in a crawler-type crane. The disadvantages are as follows: in order to realize the shrinkage and broadening width of the crawlers on the two sides, there is a large space between a crawler frame and an extending beam of the chassis; when the crawler is extended outward to the maximum width, the overlapped area between the extending beam and the track frame is small, there is an unstable factor in terms of structure, which will cause shaking of the uptight post in the operation; and the broadening width of the crawler is also limited, generally less than or equal to 4300 mm. In order to further extend the broadening width and increase the overlapped area, a structure of hinge plate is adopted. Two hinge plates open during shrinkage for transportation, and the two hinge plates are folded together during extending to achieve the purpose of extending the beam and increasing the overlapped area. Although the extending width of the crawler can achieve 4600 mm, this structure also has the following disadvantages: the structure of the hinge plate itself has an unstable problem, the problem that there is a large space between a crawler frame and the extending beam of the chassis still exists, and the pile frame walking and the operation are still unstable. Thus important property parameters will be discounted, such as the height of the uptight post of the pile frame, the weight of the carrying work and the endurable maximum operation torque.

For example, patent CN101806063A titled “CRAWLER-TYPE PILE FRAME AND METHOD FOR MOUNTING THE SAME” discloses the following contents: a chassis comprises a base, a hollow extending beam, a hollow sliding beam and a sliding beam. One end of the hollow sliding beam and one end of the sliding beam are fixedly connected with a crawler walking device respectively, and the other ends thereof are movably inserted into the hollow extending beam. The crawler walking device moves with respect to the extending beam of the chassis via the hollow sliding beam and the sliding beam. When the lateral crawler walking devices of the two sides shrink inward, a front end of the sliding beam can be inserted into a hollow part of the hollow sliding beam to form an overlapped state. When the crawler walking device shrinks inward, although the sliding beam and the hollow sliding beam can form the overlapped state, the width of two lateral crawlers is extended when the crawlers extend to increase the stability of the whole pile frame, the following disadvantages still exist: in order to be convenient for transportation, the width of two lateral crawlers in shrinking state should be less than or equal to 3300 mm, therefore, when the width of two lateral crawlers is extended to the maximum size (less than or equal to 6000 mm), the sliding cross bean is completely disconnected from the hollow sliding beam, thus the practical overlapped area between the sliding beam and the extending beam is limited somewhat, so that unstable factors still exist in terms of structure.

For example, patent CN1587543A titled “ELECTRONIC HYDRAULIC CRAWLER-TYPE PILE FRAME” discloses the following contents: the chassis is also provided with a sliding beam and a fixed device, and an extending beam is of a hollow structure. One end of the sliding beam is fixed with a crawler walking device, and the other end thereof is movably inserted into the hollow extending beam. The crawler walking device can not only move with respect to the extending beam of the chassis via the sliding beam, but also can be mutually rigidly connected with the extending beam of the chassis via the fixed device. As the crawler walking device is mutually overlapped and moves oppositely with a hollow sliding seat of the chassis via the sliding beam, while an enough overlapping length between them is guaranteed, the broadening width of the crawlers walking devices on the two sides is wider than the 4300 mm in prior art and up to 5000 to 6000 mm. Meanwhile, when the crawler walking devices on the two sides are extended outward to the maximum width, the sliding beams also can maintain mutual overlapping, so the whole structural stability of the pile frame walking and the operation is further guaranteed and improved. While when the crawler walking device shrinks, the width still maintain to be less than or equal to 3300 mm, thus the machine can be transported without dismounting the crawler. Yet the following disadvantages still exist: if a large crawler pile frame requires the width of the crawler walking devices on the two sides to be wider (larger than 6000 mm), owing to the width limitation of the structure, the sliding beam and the hollow sliding beam will be disconnected from each other, and the practical overlapped area between the sliding beam and the extending beam is limited, unstable factors still exist in terms of structure.

Patent CN101402377A discloses a telescopic crawler chassis. The crawler chassis comprises a left crawler frame, a right crawler frame, a left telescopic oil cylinder, a right telescopic oil cylinder and a center frame. The left telescopic crawler oil cylinder is arranged between the centre frame and the left crawler frame, and the right telescopic crawler oil cylinder is arranged between the centre frame and the right crawler frame, the left crawler frame comprises a left telescopic beam. The right crawler frame comprises a right telescopic beam, the left telescopic beam is matched with a left telescopic hole of the center frame, and the right telescopic beam is matched with a right telescopic hole of the center frame; the telescopic direction of the left telescopic oil cylinder is parallel to a centre line of the left telescopic hole, and the telescopic direction of the right telescopic oil cylinder is parallel to a centre line of the right telescopic hole. A wider width of the telescopic crawler chassis can be realized easier, but when the width is extended to the maximum, unstable factors still exist in terms of structure.

### SUMMARY OF THE INVENTION

On one hand, the technical problem to be solved in the present invention is to provide a telescopic crawler chassis with more rational crawler chassis structure on the basis of the telescopic crawler chassis mentioned above, to make the change or conversion of the state of the engineering machinery more convenient and make the whole machine walk and operate more stably, safely and reliably.

To solve the above technical problem, the present invention provides a telescopic crawler chassis, comprising at least one fixed hollow sliding seat, further comprising at least one hollow left sliding beam and at least one right sliding beam, one end of the hollow left sliding beam is fixedly connected with the left crawler frame and the other end thereof is movably inserted into an inner cavity of the hollow sliding seat from the left end of the hollow sliding seat; one end of the right sliding beam is fixedly connected with the right crawler frame and the other end thereof is movably inserted into an inner cavity of the left sliding beam from the right end of the hollow sliding seat.

Further, the present invention provides a telescopic crawler chassis, comprising a left crawler frame, a right crawler frame, a base, at least one left telescopic oil cylinder and at least one right telescopic oil cylinder, the left telescopic oil cylinder is arranged between the base and the right crawler frame, the right telescopic oil cylinder is arranged between the base and the right crawler frame, at least one fixed hollow sliding seat is arranged on the base, the telescopic crawler chassis further comprises at least one hollow left sliding beam and at least one right sliding beam, one end of the hollow left sliding beam is fixedly connected with the left crawler frame and the other end thereof is movably inserted into an inner cavity of the hollow sliding seat from the left end of the hollow sliding seat; one end of the right sliding beam is fixedly connected with the right crawler frame and the other end thereof is movably inserted into the inner cavity of the hollow sliding seat and also into an inner cavity of the left sliding beam from the right end of the hollow sliding seat.

Further, the front end of the right sliding beam is inserted into the inner cavity of the hollow left sliding beam, when the hollow left sliding beam and the right sliding beam shrink inward or extend outward to the maximum width across the left crawler frame and the right crawler frame. The left sliding beam and the right sliding beam are overlapped together, so the overall stability of the device in terms of structure, which is supported by the telescopic crawler chassis, is further guaranteed and improved during operating.

Further, the telescopic crawler chassis further comprises a stepped intermediate transition beam, the right sliding beam is of a hollow structure with an inner cavity, the intermediate transition beam is larger at one end and smaller at the other end, the smaller end of the intermediate transition beam is movably inserted into the inner cavity of the right sliding beam, the larger end of the intermediate transition beam is located outside the inner cavity of the right sliding beam, the larger end of the intermediate transition beam can be movably inserted into the inner cavity of the hollow left sliding beam together with the right sliding beam, a slide limiting mechanism for the intermediate transition beam is arranged on the hollow right sliding beam, the right sliding beam and/or the intermediate transition beam, so that the smaller end of the intermediate transition beam cannot escape from the inner cavity of the right sliding beam during sliding and the larger end thereof cannot escape from the inner cavity of the hollow left sliding beam during sliding.

Further, the slide limiting mechanism comprises a elongated groove, a first protrusion, a long kidney-shaped groove and a second protrusion; the elongated groove is provided on the right sliding beam and extends in the axial direction of the right sliding beam; the first protrusion is correspondingly provided at the front side of the inner cavity of the hollow left sliding beam and inserted into the elongated groove, the first protrusion is movable inside the elongated groove, and the maximum stroke of the first protrusion is obstructed by the larger end of the intermediate transition beam; the long kidney-shaped groove is provided on the intermediate transition beam and extends in the axial direction of the intermediate transition beam; the second protrusion that is embedded into the long kidney-shaped groove is fitted at the front side of the inner cavity of the right sliding beam, and the second protrusion is movable inside the long kidney-shaped groove during the slide of the sliding beams. During the outward extending of the crawler walking devices on the two sides, the protrusions are contacted with the larger end of the intermediate transition beam and the right end of the long kidney-shaped groove, the intermediate transition beam is stretched from the sliding beams. The crawler walking devices on the two sides extend outward to the maximum design width, and larger overlapped area of the sliding beams on the two sides can also be guaranteed by the intermediate transition beam, so the overalls stability of the pile frames is further guaranteed and improved in terms of structure during walking and operating.

Further, positioning pin holes are provided on the hollow sliding seat, the hollow left sliding beam and the right sliding beam, and the hollow left sliding beam and the right sliding beam are mutually fixed with the hollow sliding seat by positioning pin shafts that pass through the positioning pin holes.

Further, the hollow sliding seat comprises a front hollow sliding seat and a rear hollow sliding seat, and the left sliding beam comprises a front left sliding beam and a rear left sliding beam; the right sliding beam comprises a front right sliding beam and rear right sliding beam; the front hollow sliding seat is fitted with the front left sliding beam and the front right sliding beam, and the rear hollow sliding seat is fitted with the rear left sliding beam and the rear right sliding beam.

Further, the front hollow sliding seat is located at the front part of the base; and the rear hollow sliding seat is located at the rear part of the base, and the front hollow sliding seat is parallel to the rear hollow sliding seat.

Further, the left telescopic oil cylinder is provided between the front left sliding beam and the rear left sliding beam, and the right telescopic oil cylinder is provided between the front right sliding beam and the rear right sliding beam.

Further, the hollow sliding seat runs through the left side and right side of the base.

The above improvements or preferred technical solutions may be implemented separately or together, if not conflicted. The position of the hollow left sliding beam and the right sliding beam, as well as the position of other left and right components may be exchanged.

On the other hand, the technical problem to be solved in the present invention is to provide a crawler-type engineering machinery with more rational crawler chassis structure, to make the change or conversion of the working state of the engineering machinery more convenient and make the whole machine walk and operate more stably, safely and reliably.

To solve the above technical problem, the present invention provides a crawler-type engineering machinery, comprising a crawler chassis that is the telescopic crawler chassis according to any one of technical schemes above.

The crawler-type engineering machinery provided in the present invention comprises crawler-type piling machinery, crawler-type drills, crawler-type pile presses, crawler-type rammers, crawler-type diggers, crawler-type mills, crawler-type blenders, crawler-type conveyors, crawler-type operation trucks, crawler-type cranes, and crawler-type mine machinery and the like.

The telescopic crawler chassis in the present invention has the following active effects and advantages: as the left and right crawlers are overlapped with the hollow sliding seat of the chassis in the aid of the sliding beams and do relative movement, the size (may up to 6000-7000 mm) of the crawler walking devices on the two sides is extended to be wider than that (5000-6000 mm) of the prior art while ensuring an enough overlapped area between the sliding beams and the hollow sliding seat, and the stability of the engineering machinery is improved during walking and operating. In the preferred embodiments, a larger overlapped area between the sliding beams can still be remained in the aid of the intermediate transition beam when the crawler walking devices on the two sides extend outward to the maximum size, so the stability of the engineering machinery is further guaranteed and improved in terms of structure during walking and operating.

As the left and right crawler frames can move, shrink and extend with respect to the base and can also be rigidly and fixedly connected with the sliding beams, the stability of the engineering machinery is guaranteed in terms of structure during walking and operating. The improvement of the stability has the following advantages:

First, the safety and reliability of the engineering machinery are improved during construction, so accidents such as rolling-over of the engineering machinery may be avoided.

Second, given the same height of the upright post or cantilever of the engineering machinery, operating devices such as piling, drilling or lifting tools in a larger size may be mounted on the engineering machinery, to enlarge the application range and utilization rate of the engineering machinery.

Third, given the same model of the operating devices equipped in the engineering machinery, the length of the upright post or cantilever may be increased, to enlarge the operating range and improve the construction efficiency.

Fourth, under the premise of ensuring the safety and stability of the engineering machinery, it is easy to make the size of the crawler walking devices of the engineering machinery less than or equal to 3300 mm after shrinkage, so the engineering machinery may be transported or moved in a whole without detaching the crawlers. The change of the field is convenient, and the efficiency is high.

### BRIEF DESCRIPTION OF THE DRAWINGS

Drawings, which form a part of the description and are provided for further understanding of the present invention, show the preferred embodiments of the present invention, and explain the principle of the present invention together with the description. In the drawings:

FIG. 1 is a main structural schematic view of the engineering machinery with a telescopic crawler chassis according to an embodiment of the present invention;

FIG. 2 is a structural schematic view of the telescopic crawler chassis according to an embodiment of the present invention;

FIG. 3 is an A-A sectional structural schematic view of FIG. 2;

FIG. 4 is a structural schematic view of the structure of the chassis in a shrunk state according to the embodiment of FIG. 3;

FIG. 5 is a C-C sectional structural schematic view of FIG. 4.

### DETAILED DESCRIPTION OF THE EMBODIMENTS

The embodiments of the present invention will be described in detail below as shown in drawings, however the present invention may be implemented by various different ways defined and covered by the claims. In the drawings, identical components are indicated by identical reference number.

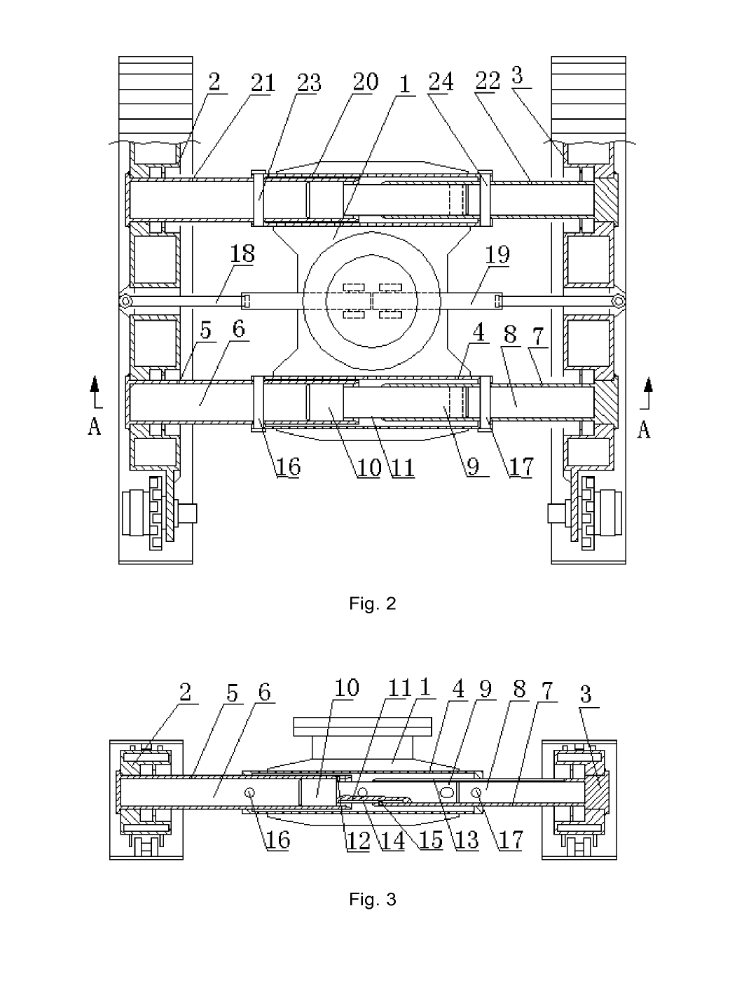

A first embodiment provides a telescopic crawler chassis for a pile press. As shown in FIG. 2, the telescopic crawler chassis comprises a base 1, a left crawler frame 2, a right crawler frame 3, a left telescopic oil cylinder 18 and a right telescopic oil cylinder 19. The base 1 is provided with a rear hollow sliding seat 4 and a front hollow sliding seat 20 that run through the left side and the right side of the base 1 and fixed on the base 1. The rear hollow sliding seat 4 is located at the rear part of the base 1, and the front hollow sliding seat 20 is located at the front part of the base 1. The rear hollow sliding seat 4 and the front hollow sliding seat 20 are parallel to each other. The telescopic crawler chassis also comprises a rear left sliding beam 5 that is hollow, a rear right sliding beam 7, a front left sliding beam 21 that is hollow and a front right sliding beam 22. One end of the hollow rear left sliding beam 5 is fixedly linked with the left crawler frame 2, and the other end thereof is movably inserted into an inner cavity of the hollow sliding seat 4 from the left end of the hollow sliding seat 4. One end of the rear right sliding beam 7 is fixedly linked with the right crawler frame 3, and the other end thereof is movably inserted into the inner cavity of the hollow sliding seat 4 and a first inner cavity 6 of the right crawler frame 5 from the right end of the hollow sliding seat 4. One end of the hollow front left sliding beam 21 is fixedly linked with the left crawler frame 2, and the other end thereof is movably inserted into an inner cavity of the front hollow sliding seat 20 from the left end of the front hollow sliding seat 20. One end of the front right sliding beam 22 is fixedly linked with the right crawler frame 3, and the other end thereof is movably inserted into the inner cavity of the hollow sliding seat 20 and an inner cavity of the front left sliding beam 21 from the right end of the front hollow sliding seat 20. The hollow sliding seat 4, the hollow rear left sliding beam 5 and the rear right sliding beam 7 are provided with a plurality of positioning pin holes, and the hollow rear left sliding beam 5 and the rear right sliding beam 7 are fixed with the hollow sliding seat 4 by positioning pin shafts 16 and 17, respectively. The front hollow sliding seat 20, the hollow front left sliding beam 21 and the front right sliding beam 22 are also provided with a plurality of positioning pin holes, and the hollow front left sliding beam 21 and the front right sliding beam 22 are fixed with the front hollow sliding seat 20 by positioning pin shafts 23 and 24, respectively. The extended width of the left crawler frame 2 and the right crawler frame 3 can be conveniently adjusted using the plurality of positioning pin holes. The left telescopic oil cylinder 18 is arranged between the base 1 and the right crawler frame 2, and the right telescopic oil cylinder 19 is arranged between the base 1 and the right crawler frame 3. The left telescopic oil cylinder 18 is located between the rear left sliding beam 5 and the front left sliding beam 21, and the right telescopic oil cylinder 19 is located between the rear right sliding beam 7 and the front right sliding beam 22.

As shown in FIG. 3, the rear right sliding beam 7 of the telescopic crawler chassis of the first embodiment is of a hollow structure with a second inner cavity 8. A stepped rear intermediate transition beam 11 is arranged in the rear left sliding beam 5 and the second inner cavity 8 of the rear right sliding beam 7. The smaller end 9 of the rear intermediate transition beam 11 is movably inserted into the inner cavity 8 of the rear right sliding beam 7. The larger end 10 of the intermediate transition beams 11 is located outside the inner cavity 8 of the rear right sliding beam. The larger end 10 of the rear intermediate transition beam 11 can be movably inserted into the first inner cavity 6 of the hollow rear left sliding beam 5 together with the rear right sliding beam 7. The rear right sliding beam 7 is provided with an axial elongated groove 13. A protrusion 12 that is embedded into the axial elongated groove 13 is fitted at the front end of the first inner cavity 6 of the rear left sliding beam 5. The protrusion 12 is movable inside the elongated groove 13 during the sliding of the sliding beam and is obstructed by the larger end 10 of the rear intermediate transition beam 11. An axial long kidney-shaped groove 14 is arranged on the rear intermediate transition beam 11. A protrusion 15 that is embedded into the axial long kidney-shaped groove 14 is fitted at the front end of the second inner cavity 8 of the rear right sliding beam 7. The protrusion 15 is movable inside the axial long kidney-shaped groove 14 during the sliding of the sliding beam so that, during the sliding, the smaller end 9 of the rear intermediate transition beam 11 cannot be disengaged from the second inner cavity 8 of the rear right sliding beam 7 and the larger end 10 of the rear intermediate transition beam 11 cannot be disengaged from the first inner cavity 6 of the rear left sliding beam 5. The inner cavity of the front left sliding beam 21 and an inner cavity of the a front right sliding beam 22 of the telescopic crawler chassis are also provided with a front intermediate transition beam and a slide limiting mechanism, which are of the same structures as the aforesaid ones, hence no more detailed description here. Positioning pin holes for fixing positioning pin shafts are arranged between the rear intermediate transition beam 11 and the front intermediate transition beam.

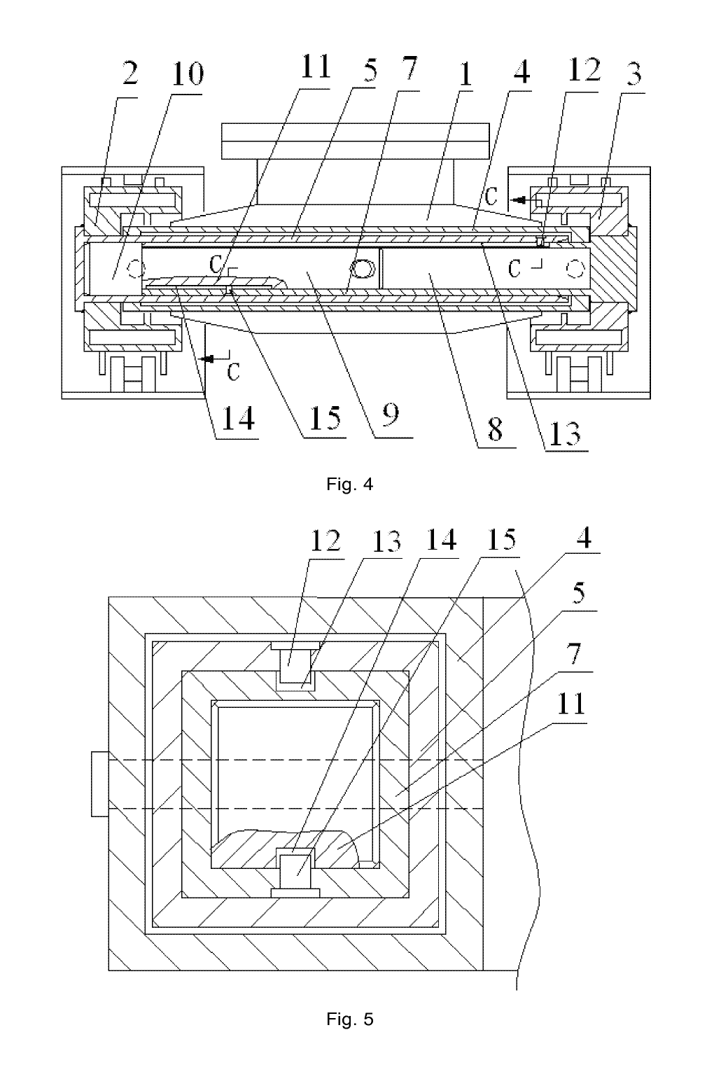

The telescopic crawler chassis provided in the first embodiment works according to the following procedures: when the pistons of the left telescopic oil cylinder 18 and the right telescopic oil cylinder 19 are in the shrunk state (as shown in FIG. 2), as shown in FIG. 4 and FIG. 5, the rear left sliding beam 5 and the front left sliding beam 21 are located in the inner cavities of the rear hollow sliding seat 4 and the front hollow sliding seat 20. The hollow rear right sliding beam 7 and the front right sliding beam 22 extend into the inner cavities of the rear left sliding beam 5 and the front left sliding beam 21 through the right ends of the rear hollow sliding seat 4 and the front hollow sliding seat 20, and the telescopic crawler chassis shrinks to the narrowest state to facilitate transportation and site transfer. During the construction, when the width of the crawler chassis needs to be extended, the pistons of the left telescopic oil cylinder 18 and the right telescopic oil cylinder 19 extend out of the cylinders to push the right crawler frame 2 and the right crawler frame 3 to move to two lateral sides, respectively. Referring to FIG. 2 and FIG. 3 again, the rear left sliding beam 5 and the front left sliding beam 21 move leftwards with respect to the rear hollow sliding seat 4 and the front hollow sliding seat 20, respectively, and the hollow rear right sliding beam 7 and the front right sliding beam 22 move rightwards with respect to the with respect to the rear hollow sliding seat 4 and the front hollow sliding seat 20, respectively. During the outward extending of the right crawler frame 2 and the right crawler frame 3, when the sliding beams move to certain positions, the protrusions at the front ends of the inner cavities of the rear left sliding beam 5 and the front left sliding beam 21 are contacted with the larger ends of the intermediate transition beams, respectively, and enable the two intermediate transition beams to extend out from the inner cavities of the hollow rear right sliding beam 7 and the front right sliding beam 22, respectively. The protrusions at the front ends of the inner cavities of the hollow rear right sliding beam 7 and the front right sliding beam 22 are contacted with the right ends of the axial long kidney-shaped grooves on the rear intermediate transition beam 11 and the front intermediate transition beam, respectively (only the rear intermediate transition beam 11 is taken as an example for describing the present invention, and the front intermediate transition beam does not shown in the drawings) and enable the rear intermediate transition beam 11 and the front intermediate transition beam to extend out from the inner cavities of the rear left sliding beam 5 and the front left sliding beam 21, respectively. So that when the right crawler frame 2 and the right crawler frame 3 are extended outwardly to the maximum design width, the rear intermediate transition beam 11 and the front intermediate transition beam can be utilized to keep more mutual overlapping between the sliding beams at the two sides, thus further ensuring the structure and improving the stability during the machinery construction work. Generally, when the crawler is within a certain width, e.g. less than 6,000 mm, the right sliding beam 7 will always be located in the inner cavity of the left sliding beam 5; when the width of the crawler is greater than 6,000 mm, the right sliding beam 7 will need to be assisted by an intermediate transition beam to extend into the inner cavity of the left sliding beam 5.

During the movement of the sliding beams, after the right crawler frame 2 and the right crawler frame 3 reach a certain preset position, the corresponding sliding beams, hollow sliding seats and intermediate transition beams are locked by the positioning pin shafts 16, 17, 23 and 24 to enable the crawler chassis in the condition of operator or site transfer.

According to the above description, when performing state change, the telescopic crawler chassis provided in the first embodiment can control the left telescopic oil cylinder 18 and the right telescopic oil cylinder 19 through a hydraulic system and then further drives the right crawler frame 2 and the right crawler frame 3 to move, thus the width between the right crawler frame 2 and the right crawler frame 3 is changed. The operation process is greatly simplified and the operability of the state change of the telescopic crawler chassis is improved. Meanwhile, as when the telescopic crawler chassis is in the operation state, great mutual overlapping exists between the sliding beams and the hollow sliding seat, in particular that more mutual overlapping can be maintained between the sliding beams at the two sides with the assistance of the intermediate transition beams, the rigidity and strength of the crawler chassis can be ensured during the operation and the rigidity and strength requirements of the construction work can be met. Therefore, the telescopic crawler chassis can be applied in large engineering machineries such as pile presses.

In this embodiment, in order to ensure a greater extending span of the telescopic crawler chassis during the operation, the front and the rear hollow sliding seats both run through the left end and the right end of the base 1. Compared with the width during site transfer, the telescopic crawler chassis provided by the present invention can be extended to a larger width than the width of the base 1 during the operation.

In this embodiment, the left telescopic oil cylinder 18 and the right telescopic oil cylinder 19 are symmetrical to each other on the right side and the left side, and the extension lines of the two cylinders in the telescopic directions pass through the centers of the rotary support of the base 1 and the crawler frames. When the right crawler frame 2 and the right crawler frame 3 move to the two sides, the right crawler frame 2 and the right crawler frame 3 can be ensured to undergo balanced stress, thus avoiding the deflection of the right crawler frame 2 and the right crawler frame 3 that results in the cooperation between the sliding beams and the hollow sliding seats. Thus those skilled in the art can understand that in order to avoid the deflection of the right crawler frame 2 and the right crawler frame 3, a corresponding telescopic oil cylinder can be separately arranged between the corresponding sliding beams and hollow sliding seats. A plurality of telescopic oil cylinders operate simultaneously so as to push the right crawler frame 2 and the right crawler frame 3 to move simultaneously.

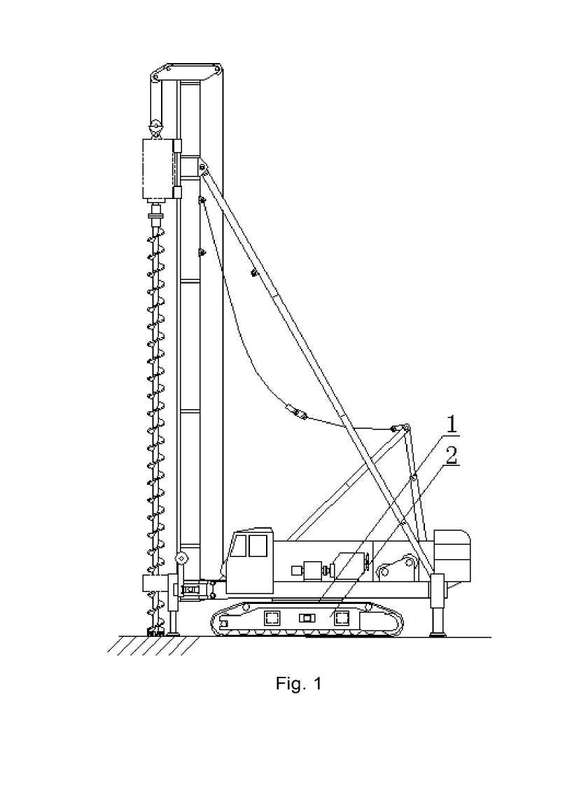

Another aspect of the present invention provides engineering machinery having the aforesaid telescopic crawler chassis. In this embodiment, a front hollow sliding seat and a rear hollow sliding seat are provided. The front hollow sliding seat 4 is located at the front portion of the base 1, the rear hollow sliding seat 20 is located at the rear portion of the base 1, and the rear hollow sliding seat 20 and the front hollow sliding seat 4 are parallel to each other. Four sliding beams are arranged symmetrically at the front and the rear and at the left and the right sides, thus ensuring the stable stress suffered by the engineering machinery, e.g., the pile press as shown in FIG. 1.

The above description only takes the pile press as shown in FIG. 1 as an example to describe the telescopic crawler chassis provided by the present invention in details. Those skilled in the art can understand that in the crawler engineering machineries of other types, the utilization of said telescopic crawler chassis can also achieve the aim of the present invention and has corresponding technical effects.

As the telescopic crawler chassis has the aforesaid technical features and effects, the crawler type engineering machinery having said telescopic crawler chassis also has the aforesaid technical features and effects.

Above contents only describe the preferred embodiments of the present invention and are not intended to limit the present invention; for one skilled in the art, the present invention may have various modifications and changes. Any modifications, equivalent replacements and improvements made within the spirit and principle of the present invention should be included within the protection scope of the present invention.

1. A telescopic crawler chassis, comprising a base, a left crawler frame and a right crawler frame, and characterized in that at least one fixed hollow sliding seat is arranged on the base, the telescopic crawler chassis further comprises at least one hollow left sliding beam and at least one right sliding beam, one end of the hollow left sliding beam is fixedly connected with the left crawler frame and the other end thereof is movably inserted into an inner cavity of the hollow sliding seat from the left end of the hollow sliding seat; one end of the right sliding beam is fixedly connected with the right crawler frame and the other end thereof is movably inserted into an inner cavity of the left sliding beam from the right end of the hollow sliding seat.

2. A telescopic crawler chassis, comprising a base, a left crawler frame, a right crawler frame, at least one left telescopic oil cylinder and at least one right telescopic oil cylinder, the left telescopic oil cylinder being arranged between the base and the right crawler frame, the right telescopic oil cylinder being arranged between the base and the right crawler frame, characterized in that at least one fixed hollow sliding seat is arranged on the base, the telescopic crawler chassis further comprises at least one hollow left sliding beam and at least one right sliding beam, one end of the hollow left sliding beam is fixedly connected with the left crawler frame and the other end thereof is movably inserted into an inner cavity of the hollow sliding seat from the left end of the hollow sliding seat; one end of the right sliding beam is fixedly connected with the right crawler frame and the other end thereof is movably inserted into an inner cavity of the left sliding beam from the right end of the hollow sliding seat.

3. The telescopic crawler chassis according to claim 1, characterized in that the front end of the right sliding beam is inserted into the inner cavity of the hollow left sliding beam when the hollow left sliding beam and the right sliding beam shrink inward or extend outward to the maximum width across the left crawler frame and the right crawler frame.

4. The telescopic crawler chassis according to claim 1, characterized in that the telescopic crawler chassis further comprises a stepped intermediate transition beam, the right sliding beam is of a hollow structure with an inner cavity, the intermediate transition beam is larger at one end and smaller at the other end, the smaller end of the intermediate transition beam is movably inserted into the inner cavity of the right sliding beam, the larger end of the intermediate transition beam is located outside the inner cavity of the right sliding beam, the larger end of the intermediate transition beam can be movably inserted into the inner cavity of the hollow left sliding beam together with the right sliding beam, a slide limiting mechanism for the intermediate transition beam is arranged on the hollow right sliding beam, the right sliding beam and/or the intermediate transition beam, so that the smaller end of the intermediate transition beam cannot escape from the inner cavity of the right sliding beam during sliding and the larger end thereof cannot escape from the inner cavity of the hollow left sliding beam during sliding.

5. The telescopic crawler chassis according to claim 4, characterized in that the slide limiting mechanism comprises an elongated groove, a first protrusion, a long kidney-shaped groove and a second protrusion; the elongated groove is provided on the right sliding beam and extends in the axial direction of the right sliding beam; the first protrusion is correspondingly provided at the front end of the inner cavity of the hollow left sliding beam and inserted into the elongated groove, the first protrusion is movable inside the elongated groove, and the maximum stroke of the first protrusion is obstructed by the larger end of the intermediate transition beam; the long kidney-shaped groove is provided on the intermediate transition beam and extends in the axial direction of the intermediate transition beam; the second protrusion that is embedded into the long kidney-shaped groove is fitted at the front end of the inner cavity of the right sliding beam, and the second protrusion is movable inside the long kidney-shaped groove.

6. The telescopic crawler chassis according to claim 1, characterized in that positioning pin holes are provided on the hollow sliding seat, the hollow left sliding beam and the right sliding beam, and the hollow left sliding beam and the right sliding beam are mutually fixed with the hollow sliding seat by the positioning pin shafts respectively.

7. The telescopic crawler chassis according to claim 2, characterized in that the hollow sliding seat comprises a front hollow sliding seat and a rear hollow sliding seat, and the left sliding beam comprises a front left sliding beam and a rear left sliding beam; the right sliding beam comprises a front right sliding beam and rear right sliding beam; the front hollow sliding seat is fitted with the front left sliding beam and the front right sliding beam, and the rear hollow sliding seat is fitted with the rear left sliding beam and the rear right sliding beam.

8. The telescopic crawler chassis according to claim 7, characterized in that the front hollow sliding seat is located at the front part of the base; the rear hollow sliding seat is located at the rear part of the base, and the front hollow sliding seat is parallel to the rear hollow sliding seat.

9. The telescopic crawler chassis according to claim 7, characterized in that the left telescopic oil cylinder is provided between the front left sliding beam and the rear left sliding beam, and the right telescopic oil cylinder is provided between the front right sliding beam and the rear right sliding beam.

10. The telescopic crawler chassis according to claim 1, characterized in that the hollow sliding seat runs through the left side and right side of the base.

11. Crawler-type engineering machinery, comprising a crawler chassis, and characterized in that the crawler chassis is the telescopic crawler chassis according to any one of the claims 1.

12. The crawler-type engineering machinery according to claim 11, characterized in that the engineering machinery comprises crawler-type piling machinery, crawler-type drills, crawler-type pile presses, crawler-type rammers, crawler-type diggers, crawler-type mills, crawler-type blenders, crawler-type excavator, crawler-type conveyors, crawler-type operation trucks, crawler-type cranes, and crawler-type mine machinery.

13. The telescopic crawler chassis according to claim 2, characterized in that the front end of the right sliding beam is inserted into the inner cavity of the hollow left sliding beam when the hollow left sliding beam and the right sliding beam shrink inward or extend outward to the maximum width across the left crawler frame and the right crawler frame.

14. The telescopic crawler chassis according to claim 2, characterized in that the telescopic crawler chassis further comprises a stepped intermediate transition beam, the right sliding beam is of a hollow structure with an inner cavity, the intermediate transition beam is larger at one end and smaller at the other end, the smaller end of the intermediate transition beam is movably inserted into the inner cavity of the right sliding beam, the larger end of the intermediate transition beam is located outside the inner cavity of the right sliding beam, the larger end of the intermediate transition beam can be movably inserted into the inner cavity of the hollow left sliding beam together with the right sliding beam, a slide limiting mechanism for the intermediate transition beam is arranged on the hollow right sliding beam, the right sliding beam and/or the intermediate transition beam, so that the smaller end of the intermediate transition beam cannot escape from the inner cavity of the right sliding beam during sliding and the larger end thereof cannot escape from the inner cavity of the hollow left sliding beam during sliding.

15. The telescopic crawler chassis according to claim 14, characterized in that the slide limiting mechanism comprises an elongated groove, a first protrusion, a long kidney-shaped groove and a second protrusion; the elongated groove is provided on the right sliding beam and extends in the axial direction of the right sliding beam; the first protrusion is correspondingly provided at the front end of the inner cavity of the hollow left sliding beam and inserted into the elongated groove, the first protrusion is movable inside the elongated groove, and the maximum stroke of the first protrusion is obstructed by the larger end of the intermediate transition beam; the long kidney-shaped groove is provided on the intermediate transition beam and extends in the axial direction of the intermediate transition beam; the second protrusion that is embedded into the long kidney-shaped groove is fitted at the front end of the inner cavity of the right sliding beam, and the second protrusion is movable inside the long kidney-shaped groove.

16. The telescopic crawler chassis according to claim 2, characterized in that positioning pin holes are provided on the hollow sliding seat, the hollow left sliding beam and the right sliding beam, and the hollow left sliding beam and the right sliding beam are mutually fixed with the hollow sliding seat by the positioning pin shafts respectively.

17. The telescopic crawler chassis according to claim 2, characterized in that the hollow sliding seat runs through the left side and right side of the base.
